(19) United States
(12) Patent Application Publication
(10) Pub. No.: US 2011/0032572 A1
(43) Pub. Date: Feb. 10, 2011

(54) JOB HISTORY DATA INSPECTION SYSTEM

(75) Inventor: Junji Sato, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/846,501

(22) Filed: Jul. 29, 2010

(30) Foreign Application Priority Data
Aug. 4, 2009 (JP) 2009-181875

(51) Int. Cl. G06F 15/00

(52) U.S. Cl. 358/1.16

(57) ABSTRACT

There is provided a job history data inspection system capable of appropriate access control on job histories. A data processing apparatus includes a reception unit configured to receive job history data about a history of a job executed by an image processing unit, a setting unit configured to acquire, based on information about a job execution user included in the job history data received by the reception unit, access right information about the job execution user and set the acquired access right information in the job history data received by the reception unit, and a storage unit configured to store in a memory unit job history data including the access right information set by the setting unit.

### BACKGROUND OF THE INVENTION

1. Field of the Invention

The present invention relates to a data processing apparatus, a job history data inspection system, a data processing method, and a program.

2. Description of the Related Art

Conventionally, job history data inspection systems acquire information about each of the jobs such as for copying, faxing, and printing executed by image processing units such as printers, scanners, and digital multifunction peripherals, and store the information as job history data in a database. These job history data inspection systems are capable of searching the database for job history data stored therein and referring to the contents of jobs executed in the past.

For example, when a user uses an image processing unit to make copies of documents, the image processing unit collects job information including the name of the user, the time when the user executes this copying operation, and the contents of the copied documents as history information, and stores the information in a database. By using a job history data inspection system, an inspector searches the database storing such job history data based on a keyword or an image, and refers to history information about the job executed by the user with the image processing unit. In this way, the inspector can inspect whether users are using devices appropriately.

However, since these job history data inspection systems store various kinds of job information, when inspectors use these systems, the inspectors could unintentionally access to such job history data that is not normally allowed to be accessed, such as confidential information or personal information.

In view of such problem, for example, Japanese Patent Application Publication No. 2007-128359 discusses a technique of limiting accessible job history data. Based on this technique, different job history data storage areas are used depending on the job history data, and access right information (access right) is set based on the job history data storage areas. In this way, the accessible job history data is limited.

However, based on such conventional job history data inspection system, since an access right is determined based on the job history data storage area, flexible access control is not enabled. In addition, since job history data storage areas are dispersed, management of the job history data is complicated.

### SUMMARY OF THE INVENTION

The present invention is directed to a job history data inspection system capable of executing appropriate access control on job history data.

According to an aspect of the present invention, a data processing apparatus is provided. The data processing apparatus includes: a reception unit configured to receive job history data about a history of a job executed by an image processing unit; a setting unit configured to acquire, based on information associated with a job execution user included in the job history data received by the reception unit, access right information about the job execution user, and set the acquired access right information in the job history data received by the reception unit; and a storage unit configured to store in a memory unit job history data including the access right information set by the setting unit.

According to another aspect of the present invention, in a job history data inspection system including a data processing apparatus and an inspection control apparatus, the data processing apparatus includes a reception unit configured to receive job history data about a history of a job executed by an image processing unit, a setting unit configured to acquire, based on information associated with a job execution user included in the job history data received by the reception unit, access right information about the job execution user, and set the acquired access right information in the job history data received by the reception unit, and a storage unit configured to store in a memory unit job history data including the access right information set by the setting unit, and wherein the inspection control apparatus includes an inspection control unit configured to acquire, based on inspector information included in an inspection request from an inspector, access right information associated with the inspector, acquire, based on identification information that is included in the inspection request and that identifies job history data to be inspected, the job history data from the memory unit, and determine, based on access right information set in the acquired job history data and the acquired access right information associated with the inspector, whether to exclude the job history data to be inspected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a job history data inspection system.

FIG. 2 is a block diagram illustrating a hardware configuration of an information processing unit (such as a server and a personal computer (PC)) included in the job history data inspection system.

FIG. 3 is a block diagram illustrating functional configuration of a data processing server.

FIG. 4 is a flow chart illustrating job history storage processing executed by the data processing server according to a first exemplary embodiment.

FIGS. 5A to 5C illustrate job history examples.

FIG. 6 illustrates an access right acquired by an access right setting unit from a lightweight directory access protocol (LDAP) server.

FIG. 7 is a flow chart illustrating inspection control processing executed by a search server.

FIG. 8 illustrates access right information associated with an inspector acquired by the search server in step S702.

FIG. 9 illustrates functional configuration of a data processing server according to a second exemplary embodiment.

FIG. 10 illustrates access right definitions.

FIG. 11 is a flow chart illustrating job history storage processing executed by the data processing server according to the second exemplary embodiment.

### DESCRIPTION OF THE EMBODIMENTS

Various exemplary embodiments, features, and aspects of the invention will be described in detail below with reference to the drawings.

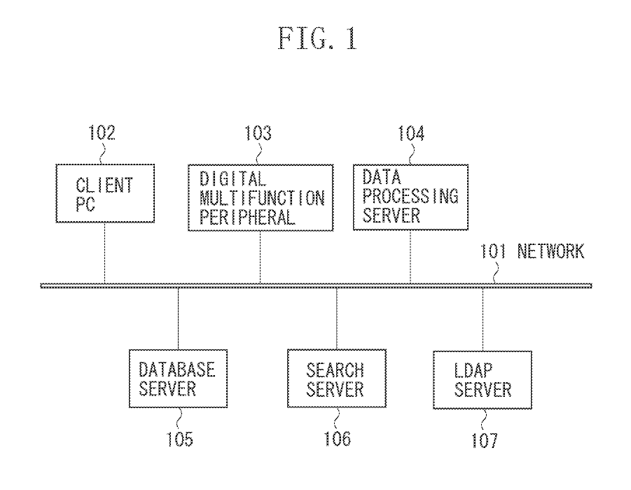

FIG. 1 is a block diagram illustrating a configuration of a job history data inspection system, in which a client PC 102, a digital multifunction peripheral 103, a data processing server 104, a database server 105, a search server 106, and an LDAP server 107 are connected to each other via a network 101. The digital multifunction peripheral 103 is an example of an image processing unit, and the data processing server 104 is an example of a data processing apparatus. Further, the database server 105 is an example of a memory unit, and the search server 106 is an inspection control unit, for example.

The network 101 is a local area network (LAN) used in an office or a wide area network (WAN) used in a wide area through the Internet. The job history data inspection system (hereinafter referred to as job history inspection system) includes the network 101, an image processing unit such as a digital multifunction peripheral, a PC, and a server connected to the network 101.

The client PC 102 includes a print driver that functions when a printing process is carried out by application software. In addition, the client PC 102 includes add-in software to extend functions of the print driver. The add-in software acquires job history data (hereinafter referred to as job history) concerning print data transmitted from the client PC 102 to the digital multifunction peripheral 103.

PC agent software transfers the job history acquired by the client PC 102 to the data processing server 104. The agent software may be previously installed in the client PC 102 or in a print server (not illustrated) arranged on the network 101.

The digital multifunction peripheral 103 includes an agent function. When a user controls the digital multifunction peripheral 103 to execute a job such as for copying or faxing, the agent function acquires a job history and sends the job history to the data processing server 104. For example, the job history includes attribute information such as the job type, the job execution date and time, and the name of the user who executed the job, and contents data such as image data or text data input or output when the job is executed.

The data processing server 104 receives the job history transferred from the client PC 102 and the digital multifunction peripheral 103 through the network 101. The data processing server 104 executes data processing on the received job history. For example, the data processing server 104 sets access rights in job histories and stores data in the database server 105.

The data processing server 104 executes data processing such as image resolution conversion, data compression, and data format conversion. In addition, the data processing server 104 executes data processing for extracting text data by using an optical character reader (OCR) and extracting image feature amounts for image search, for example.

Image feature amounts are values indicating features of images, examples of which include luminance information, color information, edge information, and values obtained by executing a certain algorithm on such information. The image feature amounts are used to search for images.

The data processing server 104 uses the LDAP server 107 to acquire access right information (hereinafter referred to as access right) about a job history, based on contents of the job history. The data processing server 104 uses open database connectivity (ODBC) or other data providers to store data in the database server 105.

The database server 105 includes a large capacity storage including at least one hard disk drive (HDD), and a database (DB) is established in the large capacity storage. The DB includes at least one data table having an application-specific structure.

A database management system (DBMS) that operates on the database server 105 manages the DB and ensures the consistency of data during data addition, update, search, or the like. Job histories are stored in the database server 105 via the DBMS. As long as job histories can be stored in a memory unit, an arbitrary server may be used as a database server applicable to the first exemplary embodiment. A file server may be used as the database server, for example.

The search server 106 receives a search condition from an inspector, acquires job histories that satisfy the search condition among the job histories stored in the database server 105, and provides the inspector with the acquired job histories. In addition, the search server 106 includes an inspection control function. More specifically, the search server 106 determines whether the inspector who has issued a search request has a right to access to the requested job logs and limits access to the job logs if necessary.

The search server 106 is configured with a Web application, and inspectors use a Web browser to access to the search server 106. Examples of the search condition include job attribute information such as a job execution user, a date and time of the job execution, and a character string included in text data.

The LDAP server 107 uses the LDAP to provide company directory information, namely, to provide a directory service for managing information about the electronic mail (e-mail) addresses of users using the network or information about the organizations using the network. In addition, the directory service applicable to the first exemplary embodiment is not limited to the LDAP. As long as functions of a directory service are enabled, an arbitrary type of directory service may be used.

In FIG. 1, while only one component is used for each of the client PC 102 to the LDAP server 107 in the network 101, a plurality of components may be used for each of the client PC 102 to the LDAP server 107. In addition, different components may be arranged in an identical server. For example, the data processing server 104 and the search server 106 may be configured in an identical unit.

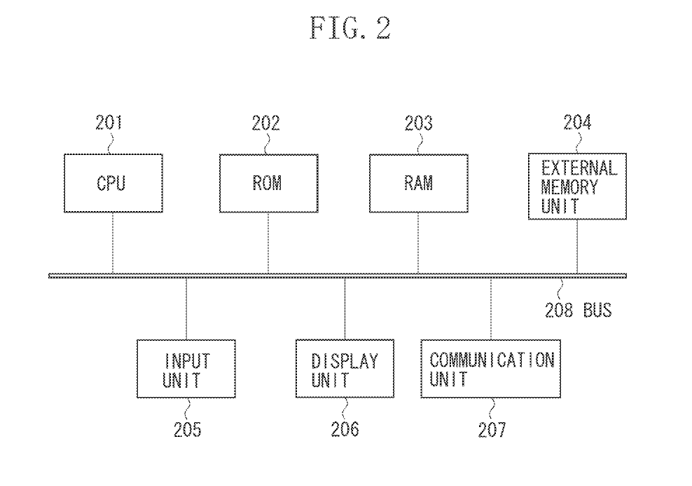

FIG. 2 is a block diagram illustrating a hardware configuration of an information processing unit (such as a server and a PC) included in the job history inspection system.

In FIG. 2, a central processing unit (CPU) 201 executes various kinds of data processing to acquire job histories and arithmetic processing for searching. The CPU 201 controls each of the components connected to a bus 208. A read-only memory (ROM) 202 stores basic control programs. A random access memory (RAM) 203 is used for various kinds of arithmetic processing executed by the CPU 201 or used for temporary storage of data.

An external memory unit 204 is used for the system program of the operating system (OS) of the information processing unit and programs of the job history inspection system. The external memory unit 204 is also used as a temporary storage area for data being processed. While the external memory unit 204 is slower in inputting and outputting data, the external memory unit 204 is capable of holding a larger amount of data, compared with the RAM 203. A magnetic memory unit (HDD) is mainly used as the external memory unit 204. Alternatively, an external medium such as a compact disc (CD), a digital versatile disc (DVD), or a memory card may be used to read or record data.

An input unit 205 is used to input characters and data to the information processing unit, examples of which include various types of keyboards and mouses. A display unit 206 displays processing results obtained by the information processing unit, examples of which include a cathode ray tube (CRT) and a liquid crystal monitor. A communication unit 207 is connected to a LAN and executes data communication using transmission control protocol/Internet protocol (TCP/IP). The communication unit 207 is used for communication with other information processing units.

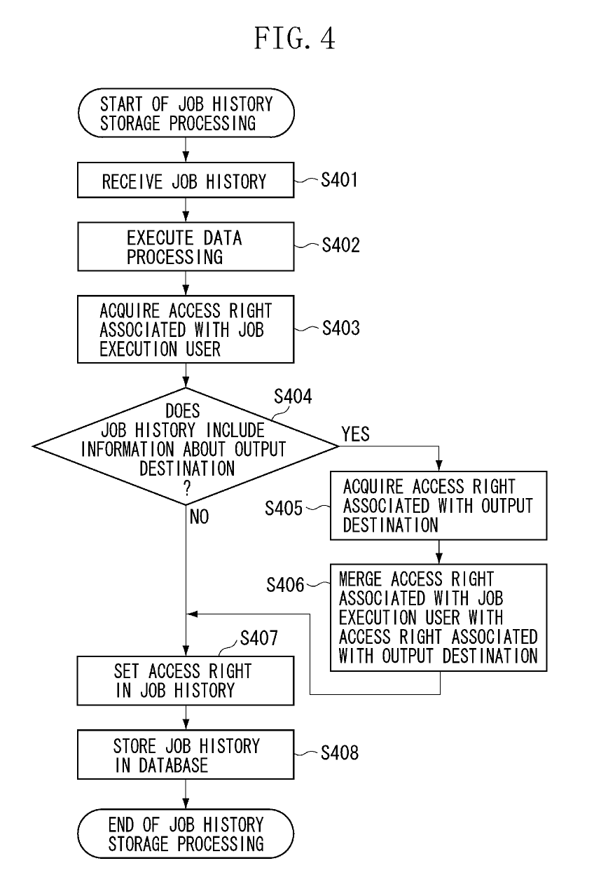

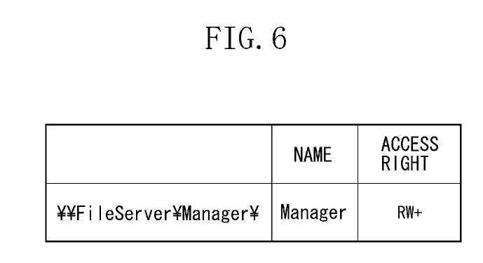

The CPU 201 of the data processing server 104 executes processing based on programs stored in the ROM 202 or the external memory unit 204, to realize functions of the data processing server 104 and processing of a flow chart illustrated in FIG. 4. Further, the CPU 201 of the search server 106 executes processing based on programs stored in the ROM 202 or the external memory unit 204, to realize processing of a flow chart illustrated in FIG. 6 executed by the search server 106.

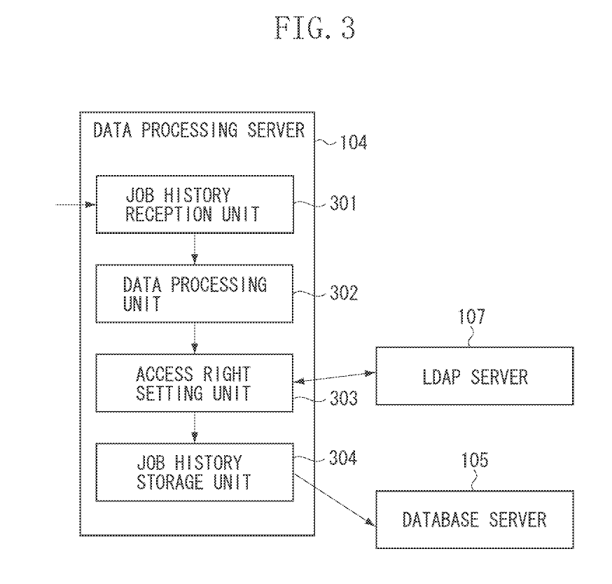

FIG. 3 is a block diagram illustrating an example of functional configuration of the data processing server 104.

In FIG. 3, the data processing server 104 includes a job history reception unit 301, a data processing unit 302, an access right setting unit 303, and a job history storage unit 304 as functional configuration that realize job history processing. These function configuration are software modules that operate on the data processing server 104.

The job history reception unit 301 receives job histories sent from the client PC 102 and the digital multifunction peripheral 103. The data processing unit 302 executes data processing on the job histories received by the job history reception unit 301. Examples of the data processing include resolution conversion, data compression, and data format conversion. Further, the data processing unit 302 includes a function of extracting image feature amounts that quantitatively define image features. The image feature amounts are parameters used for image search.

Depending on the contents of a job history, the access right setting unit 303 sends an inquiry to the LDAP server 107 to acquire an access right, and sets the acquired access right in the job history. The job history storage unit 304 stores the job history including the access right set by the access right setting unit 303 in the database server 105.

FIG. 4 is a flow chart illustrating job history storage processing executed by the data processing server 104 according to the first exemplary embodiment.

The data processing server 104 includes a CPU and memory units such as a RAM, a ROM, and a HDD, in which programs are stored. The CPU runs these programs to execute processing of the flow chart of FIG. 4.

In step S401, the job history reception unit 301 receives a job history from the client PC 102 or the digital multifunction peripheral 103. In step S402, the data processing unit 302 executes data processing on the job history received in step S401.

In step S403, the access right setting unit 303 uses a value included in the job history as user information, for example, the name of the user who has executed the job (job execution user), to acquire an access right of the user from the LDAP server 107.

In step S404, the access right setting unit 303 determines whether the job history includes information about an output destination (output destination information). If the job is transmission of an e-mail, the output destination information corresponds to a destination address of the e-mail. If the job is storage of a scanned image in a file server as a file, the output destination information corresponds to a directory path of the file server.

If the job history includes output destination information (YES in step S404), in step S405, the access right setting unit 303 acquires an access right about the output destination from the LDAP server 107.

In step S406, the access right setting unit 303 uses a predetermined algorithm to merge the access right associated with the job execution user acquired in step S403 with the access right associated with the output destination acquired in step S405. An administrator of the job history inspection system sets this algorithm in advance. For example, the access rights may be merged based on sum of sets or by giving priority to the access right associated with the output destination.

In step S407, the access right setting unit 303 sets the access right acquired in step S403 or the access rights merged in step S406 in the job history. In step S408, the job history storage unit 304 stores the job history including the access right(s) in the database server 105.

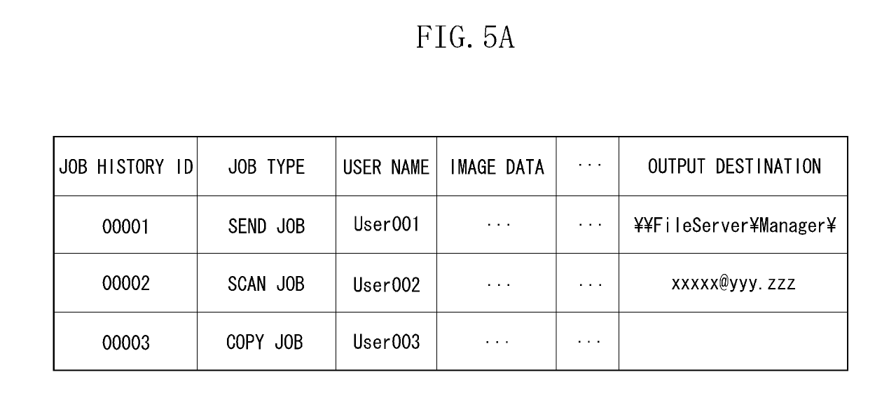

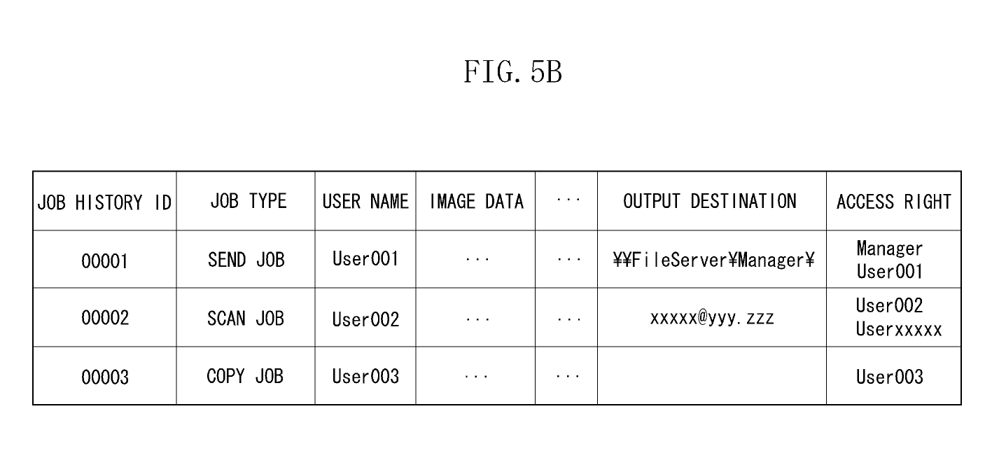

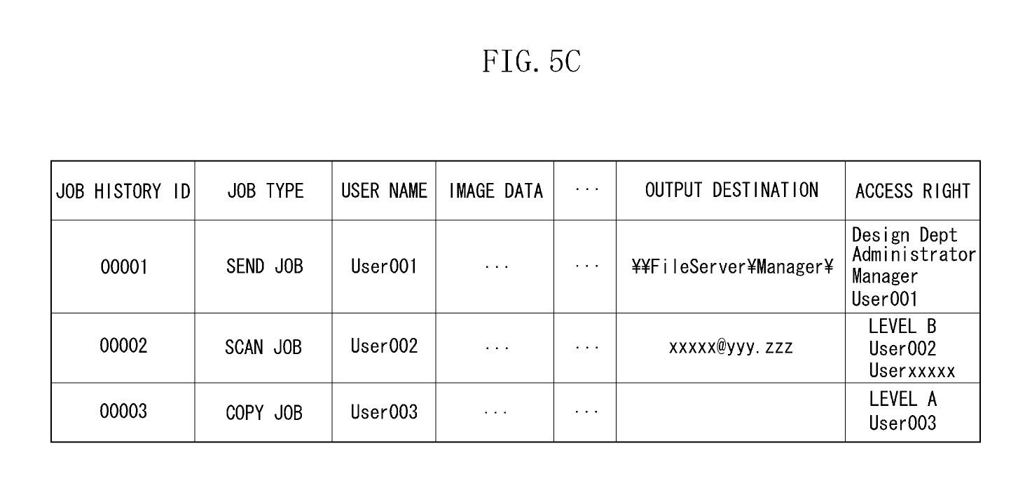

FIGS. 5A to 5C illustrate job history examples. FIG. 5A illustrates job histories before access rights are set. FIG. 5B illustrates job histories after access rights are set by the access right setting unit 303 in the job histories in FIG. 5A. Each of the FIGS. 5A to 5C illustrates three job histories having job history IDs 00001, 00002, and 00003. A job history includes job information such as a job history ID, a job type, a user name, and image data.

In FIG. 5B, the job history having the job history ID “CCCC1” includes user group information “Manager” and user information “User001” as access rights. Since the job history having the job history ID “00001” includes “YYFileServerYManagerY” as the output destination information, the access right setting unit 303 acquires “Manager” as an access right from the LDAP server 107. Likewise, since the job history includes “User001” as the job execution user, the access right setting unit 303 acquires “User001” as an access right from the LDAP server 107.

The job history having the job history ID “00002” includes a mail address as the output destination information. In such case, the access right setting unit 303 sends an inquiry to the LDAP server 107 to acquire user information associated with the mail address and sets the user information as an access right. In the example in FIG. 5B, a user “Userxxxxx” corresponding to the output destination information “xxxxx@yyy.zzz” is set as an access right of the job history having the job history ID “00002”.

The job history having the job history ID “00003” indicates a copy job that does not involve any output destination. Thus, the box for the output destination information of the job history is left blank. If the access right setting unit 303 determines that a job history includes no output destination information (No in step S404 of the flow chart of FIG. 4), the access right setting unit 303 sets no output destination as an access right. Thus, in the job history having the job history ID “00003”, the access right setting unit 303 sets only the job execution user “User00003” as an access right.

FIG. 6 illustrates an example of an access right acquired by the access right setting unit 303 from the LDAP server 107. FIG. 6 illustrates that a group of users named as “Manager” has an access right “RW+” to a directory “YYFileServerYManagerY”. The LDAP server 107 manages the user group information “Manager”, and the user group named as “Manager” is composed of at least one user. The attribute “RW+” represents that “Manager” is allowed to refer to and change data in the directory.

Once stored in the database server 105, job histories are not changed. Therefore, while the access right setting unit 303 sets access rights for job histories based on such information as illustrated in FIG. 6, the access right setting unit 303 does not change the access rights associated with the job histories. The access right setting unit 303 only manages accessibility to the job histories having the access rights.

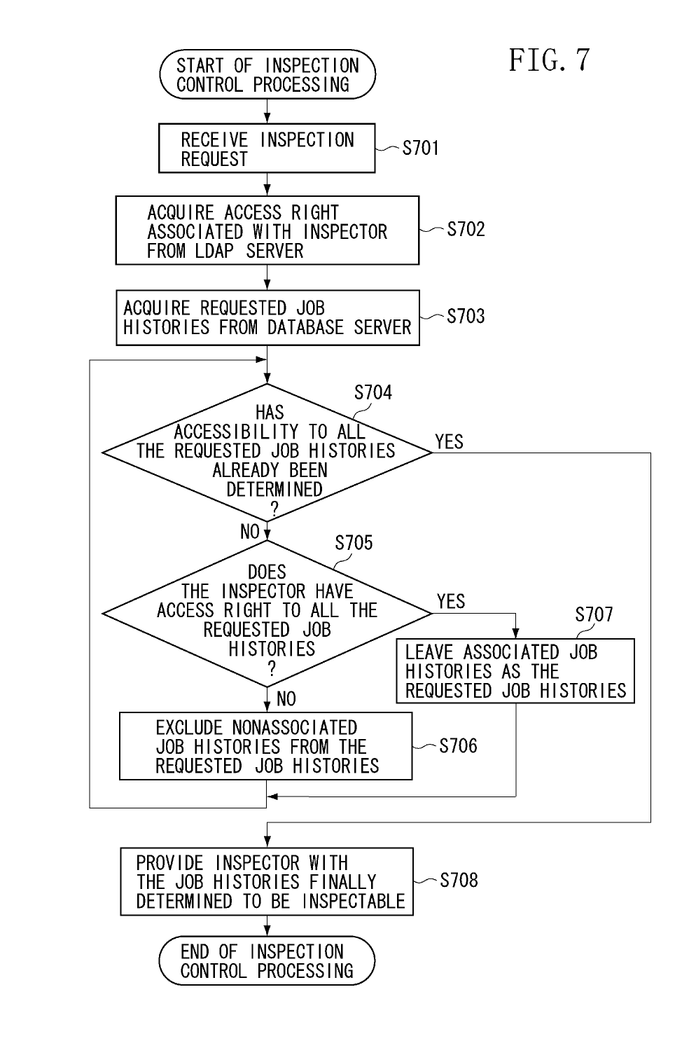

FIG. 7 is a flow chart illustrating inspection control processing executed by the search server 106. Upon receiving a job history inspection request from an inspector (from a PC of an inspector, for example), the search server 106 executes inspection control and provides the inspector with a desired job history. In the first exemplary embodiment, the search server 106 includes a CPU and memory units such as a RAM, a ROM, and a HDD in which programs are stored. The CPU runs these programs to execute processing of the flow chart of FIG. 7.

In step S701, the search server 106 receives an inspection request from an inspector. The inspection request includes a search condition for identifying requested job histories. Examples of the search condition include job history information such as a job execution user and a job type and image feature amounts included in image data.

In step S702, based on inspector information included in the inspection request, the search server 106 acquires an access right about the inspector from the LDAP server 107. In step S703, based on identification information that is included in the inspection request received in step S701 and that identifies job histories, the search server 106 acquires requested job histories to be inspected from the database server 105.

In step S704, the search server 106 determines whether accessibility of the inspector to each of the requested job histories acquired in step S703 has already been determined. If any job histories to which accessibility of the inspector has not been determined are found (NO in step S704), in step S705, the search server 106 determines whether the inspector is allowed to access to these job histories.

The search server 106 compares the access right associated with the inspector acquired in step S702 with the access rights to each of these job histories of interest. If the comparison results show that there are job histories that do not include the access right associated with the inspector (NO in step S705), in step S706, the search server 106 excludes these nonassociated job histories from the requested job histories to be inspected.

On the other hand, in step S705, if the comparison results show that the job histories include the access right associated with the inspector (YES in step S705), in step S707, the search server 106 leaves these job histories (the job histories that have just been processed) as the requested job histories to be inspected.

In step S704, if accessibility of the inspector to all the job histories acquired in step S704 has already been determined (YES in step S704), in step S708, the search server 106 provides the inspector with the job histories finally determined as inspectable. In the first exemplary embodiment, functions of the search server 106 are realized with a Web application, and thus, a PC Web browser of the inspector displays the job histories.

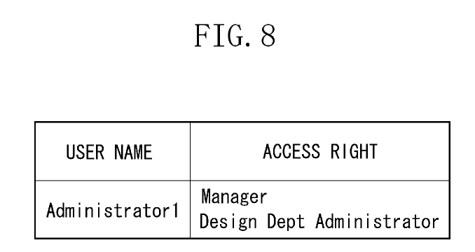

FIG. 8 illustrates access rights associated with an inspector acquired by the search server 106 in step S702.

In FIG. 8, “Manager” and “Design Dept Administrator” are set as access rights associated with an inspector “Administrator)”. Among the three job histories illustrated in FIG. 5B, the inspector “Administrator)” can inspect the job history having a job history ID 00001, since the job history includes “Manager” as an access right.

According to the first exemplary embodiment, depending on the contents of a job history, the data processing server 104 sets an access right to the job history. Thus, the range of an inspection by an inspector can be limited, and unnecessary inspection of confidential information or personal information can be prevented.

A second exemplary embodiment is the same as the first exemplary embodiment in terms of configurations illustrated in FIGS. 1, 2, and 5 to 8. In the second exemplary embodiments, elements and components which are identical to those in the first exemplary embodiment are designated by identical reference numerals, and the description thereof will be omitted. Hereinafter, aspects specific to the second exemplary embodiment will be described.

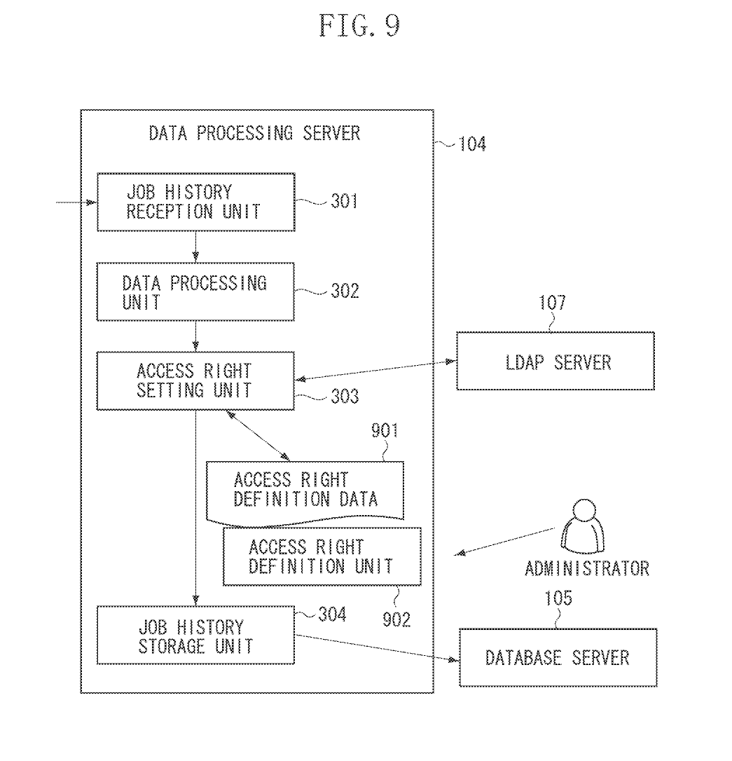

FIG. 9 illustrates functional configuration of a data processing server according to the second exemplary embodiment. The components 104, 105, 107, and 301 to 304 in FIG. 9 are the same as those illustrated in FIG. 3, and thus, only an access right definition data (access right definition) 901 and an access right definition unit 902, which are components not illustrated in FIG. 3, will be described below.

The access right definition 901 is setting information used to determine access rights associated with job histories. Administrators of the job history inspection system use the access right definition unit 902 to set the access right definition 901. The access right setting unit 303 sets access rights based on the access right definition 901, in addition to the job execution user and output destination information as described in the first exemplary embodiment. For example, the access right definition 901 is stored in a HDD of the data processing server 104.

The access right definition unit 902 includes a Web application function of changing the access right definition 901. Administrators of the job history management system can access to the access right definition unit 902 via a Web browser to check or update (edit) current contents of the access right definition 901.

When a plurality of data processing servers 104 are used to form a cluster configuration, and in order to share the access right definition 901 by each of the data processing servers 104, the job history management system manages the access right definition 901 in an integrated fashion. In this case, one server including the access right definition unit 902 maybe operated as an access right definition management server (not illustrated), and each of the data processing servers may be allowed to acquire the access right definition 901 from the access right definition management server at a given timing.

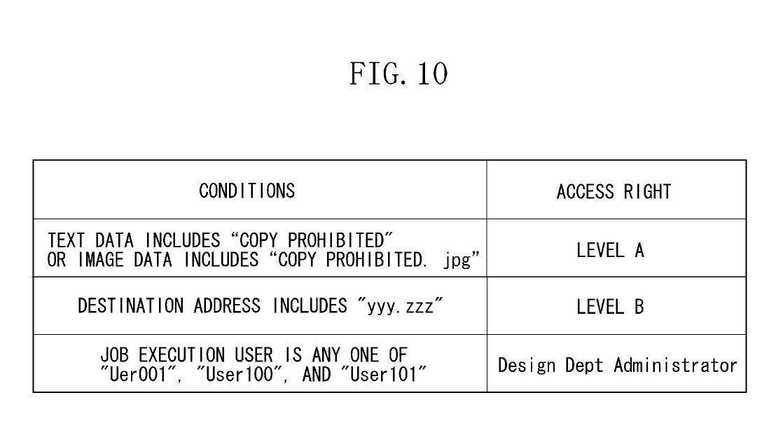

FIG. 10 illustrates access right definitions.

Based on the access right definitions in FIG. 10, if a job history includes text data including a character string “Copy Prohibited” or if a job history includes image data including “Copy Prohibited .jpg”, an access right “level A” is set in this job history. Similarly, if a job history includes a destination address including a character string “yyy.zzz”, an access right “level B” is set in this job history. Similarly, if a job execution user in a job history is any one of “User001”, “User100”, and “User101”, an access right “Design Dept Administrator” is set in this job history.

If image data in a job history includes “Copy Prohibited .jpg”, it is determined that the image feature amount of the image data in the job history is similar to the feature amount of the “Copy Prohibited .jpg”. A similar image search engine included in the data processing server 104 determines the image similarity. The similar image search engine can be realized by various known algorithms.

The access right definitions of the present invention are not limited to those illustrated in FIG. 10. Other information included in a job history may be specified by the access right definitions as conditions for determining access rights. For example, if the installation location of a digital multifunction peripheral that executed a job is used as a condition, the access right associated with the job can be changed depending on the installation location of the digital multifunction peripheral.

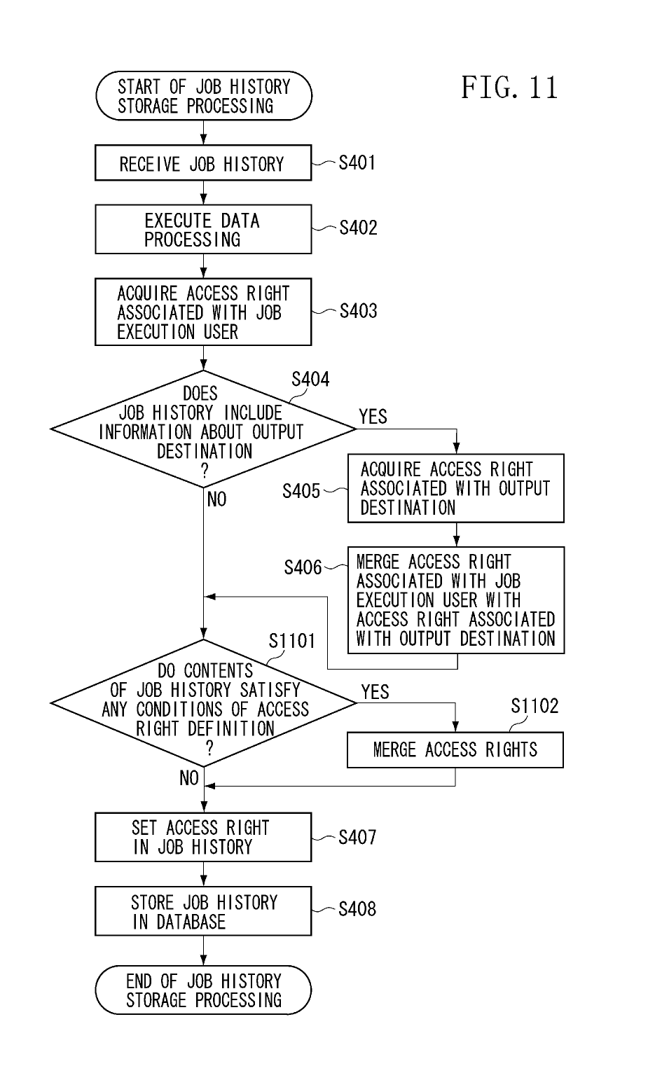

FIG. 11 is a flow chart illustrating job history storage processing executed by the data processing server 104 according to the second exemplary embodiment. Steps S401 to S408 in FIG. 11 are the same as those illustrated in FIG. 4, and thus, only steps S1101 and S1102, which are steps not illustrated in FIG. 4, will be described below.

In step S1101, the access right setting unit 303 determines whether the contents of a job history satisfy any conditions of the access right definition 901. If the contents of the job history satisfy any conditions of the access right definition 901 (YES in step S1101), the access right setting unit 303 executes processing in step S1102.

If the access right setting unit 303 determines that the job history includes no output destination information (No in step S404), in step S1102, the access right setting unit 303 uses a predetermined algorithm to merge the access right associated with the job execution user with the access right satisfied by the access right definition 901. If the access right setting unit 303 determines that the job history includes output destination information (Yes in step S404), in step S1102, the access right setting unit 303 uses a predetermined algorithm to merge the access rights merged in step S406 with the access right satisfied by the access right definition 901.

An administrator of the job history inspection system sets this algorithm in advance. For example, the access rights may be merged based on a sum of sets or by giving priority to the access right satisfied by the access right definition 901.

When the contents of a job history satisfy a plurality of conditions of the access right definition 901, the access right setting unit 303 may use all the corresponding access rights. Alternatively, the conditions of the access right definition 901 maybe provided with different priority levels, and an access right corresponding to a condition having the highest priority may be used. The latter exemplary embodiment can be realized by allowing the access right definition unit 902 to have a function of setting the condition priority levels in the access right definition 901.

FIG. 5C illustrates job histories in which access rights set by the access right setting unit 303 are added to the job histories of FIG. 5A. FIGS. 5B and 5C are the same, other than the access rights.

In FIG. 5C, three access rights “Design Dept Administrator”, “Manager”, and “User001” are set in the job history having job history ID “00001” by the access right setting unit 303. Among these access rights, the access right “Design Dept Administrator” is set based on the access right definition 901 in step S1102.

Namely, since the job history having the job history ID “00001” indicates that the job execution user is “User001”, the access right setting unit 303 sets “Design Dept Administrator” as an access right, based on the access right definition 901 illustrated in FIG. 10. Likewise, since the job history having the job history ID “00002” indicates that the output destination is “xxxxx@yyy.zzz”, the access right setting unit 303 sets “level B” as an access right, based on the access right definition 901 illustrated in FIG. 10.

The job history having the job history ID “00003” is associated with “level A” as an access right. This is because this job history includes text data including the character string “Copy Prohibited” or image data including an image similar to “Copy Prohibited .jpg”.

In FIG. 5C, all the access rights determined in steps S403, 5406, and 51102 are set. However, the access right setting unit 303 may set different access right levels, depending on the results of each of the steps.

For example, if an inspector has an access right that is determined based on the access right definition 901, the inspector may be allowed to refer to all the contents of a job history. As another example, if an inspector has an access right based on the job execution user acquired in step S403, the inspector may be allowed to refer to only the job name and the job execution date and time of the job history. For example, the inspector “Administrator1” illustrated in FIG. 8 has the access right “Design Dept Administrator”, this inspector is allowed to browse all the contents of the job history having the job history ID “00001”.

However, other inspectors who have the access right “Manager” but do not have the access right “Design Dept Administrator” are allowed to refer to only the job name and the job execution date and time, among the contents of the job history having the job history ID “00001”.

According to the second exemplary embodiment, the conditions for setting access rights in job histories can be defined (edited) arbitrarily. Therefore, detailed access rights can be set for each job history, and the scope of an inspection by an inspector can be limited more flexibly.

Thus, according to the above exemplary embodiments, since appropriate access rights can be set for each item of job history data based on the contents of the job history data, appropriate access control on job histories can be realized.

Aspects of the present invention can also be realized by a computer of a system or apparatus (or devices such as a CPU or a micro-processing unit (MPU)) that reads out and executes a program of computer-executable instructions recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

According to another aspect of the present invention, an operating system (OS) or other application software running on a computer can execute part or all of actual processing based on instructions of the program to realize the functions one or more of the above-described exemplary embodiments.

Additionally, the program read out of a storage medium can be written into a memory of a function expansion card inserted in a computer or into a memory of a function expansion unit connected to the computer. In this case, based on instructions of the program, a CPU or MPU provided on the function expansion card or the function expansion unit can execute part or all of the processing to realize the functions of one or more of the above-described exemplary embodiments.

A wide variety of computer-readable media may be used to store the program. The storage medium may be, for example, any of a flexible disk (floppy disk), a hard disk, an optical disk, a magneto-optical disk, a compact disc (CD), a digital versatile disc (DVD), a read only memory (ROM), a CD-recordable (R), a CD-rewritable, a DVD-recordable, a DVD-rewritable, a magnetic tape, a nonvolatile memory card, a flash memory device, and so forth.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-181875 filed Aug. 4, 2009, which is hereby incorporated by reference herein in its entirety.

What is claimed is:

1. A data processing apparatus comprising:
a reception unit configured to receive job history data about a history of a job executed by an image processing unit;
a setting unit configured to acquire, based on information about a job execution user included in the job history data received by the reception unit, access right information associated with the job execution user, and set the acquired access right information in the job history data received by the reception unit; and
a storage unit configured to store in a memory unit job history data including the access right information set by the setting unit.

2. The data processing apparatus according to claim 1, wherein the setting unit, when the job history data received by the reception unit includes information about an output destination of the job, acquires, based on the information about the output destination, access right information indicating an access right associated with the output destination, merges the acquired access right information indicating the access right associated with the output destination with the access right information associated with the execution user, and sets the merged access right information in the job history data received by the reception unit.

3. The data processing apparatus according to claim 1, wherein the setting unit, when contents of the job history data received by the reception unit satisfy a condition indicated by access right definition data that defines access rights to the job history data, merges the access right information associated with the job execution user with access right information about an access right defined by the access right definition data, and sets the merged access right information in the job history data received by the reception unit.

4. The data processing apparatus according to claim 3, further comprising an editing unit configured to edit the access right definition data.

5. The data processing apparatus according to claim 1, further comprising an inspection control unit configured to acquire, based on inspector information included in an inspection request from an inspector, access right information associated with the inspector, acquire, based on identification information that is included in the inspection request and that identifies job history data to be inspected, the job history data from the memory unit, and determine, based on access right information set in the acquired job history data and the acquired access right information associated with the inspector, whether to exclude the job history data to be inspected.

6. A job history data inspection system including a data processing apparatus and an inspection control apparatus, the data processing apparatus comprising:
a reception unit configured to receive job history data about a history of a job executed by an image processing unit;
a setting unit configured to acquire, based on information about a job execution user included in the job history data received by the reception unit, access right information associated with the job execution user, and set the acquired access right information in the job history data received by the reception unit; and
a storage unit configured to store in a memory unit job history data including the access right information set by the setting unit, and
wherein the inspection control apparatus includes:
an inspection control unit configured to acquire, based on inspector information included in an inspection request from an inspector, access right information associated with the inspector, acquire, based on identification information that is included in the inspection request and that identifies job history data to be inspected, the job history data from the memory unit, and determine, based on access right information set in the acquired job history data and the acquired access right information associated with the inspector, whether to exclude the job history data to be inspected.

7. A data processing method executed by a data processing apparatus, the method comprising:
receiving job history data about a history of a job executed by an image processing unit;
acquiring, based on information about a job execution user included in the job history data, access right information associated with the job execution user, and setting the acquired access right information in the job history data; and
storing in a memory unit job history data including the access right information.

8. A non-transitory computer-readable recording medium recording a program for causing a computer to execute the data processing method according to claim 7.
